(19) United States
(12) Patent Application Publication
(10) Pub. No.: US 2007/0251320 A1
(43) Pub. Date: Nov. 1, 2007

(54) Tri-axial accelerometer

(76) Inventor: Michael King Russell, Prestbury (GB)

Correspondence Address: MARK A OATHOUT, 3701 KIRBY DRIVE, SUITE 960, HOUSTON, TX, 77098, US

(21) Appl. No.: 11/414,317

(22) Filed: Apr. 28, 2006

(51) Int. Cl. G01P 15/125

(52) U.S. Cl. 73/514.32

(57) ABSTRACT

This invention relates to a tri-axial accelerometer with a magnetic sensing element, and has little or no magnetic shielding. Magnetic fields which would otherwise adversely affect the output of the accelerometer are measured and removed from the calculated accelerations in each dimension.

### FIELD OF THE INVENTION

This invention relates to a tri-axial accelerometer, and in particular to an improvement upon granted patent GB 2 213 272, the disclosure of which is incorporated herein by reference.

### BACKGROUND OF THE INVENTION

In patent document GB 2 213 272 there is disclosed a tri-axial accelerometer configured as a force balance device with a magnetic proof mass constrained to a null or zero position by an orthogonal set of electrical force coils. An advantage of the device described in that disclosure is that the use of a moving magnet enables the force coils to be body mounted and eliminates the need for electrical flexure connections.

A disadvantage of a magnetic proof mass is that the magnet will experience a torque proportional to any magnetic field (such as the Earth's magnetic field for example) perpendicular to the longitudinal (Z) axis.

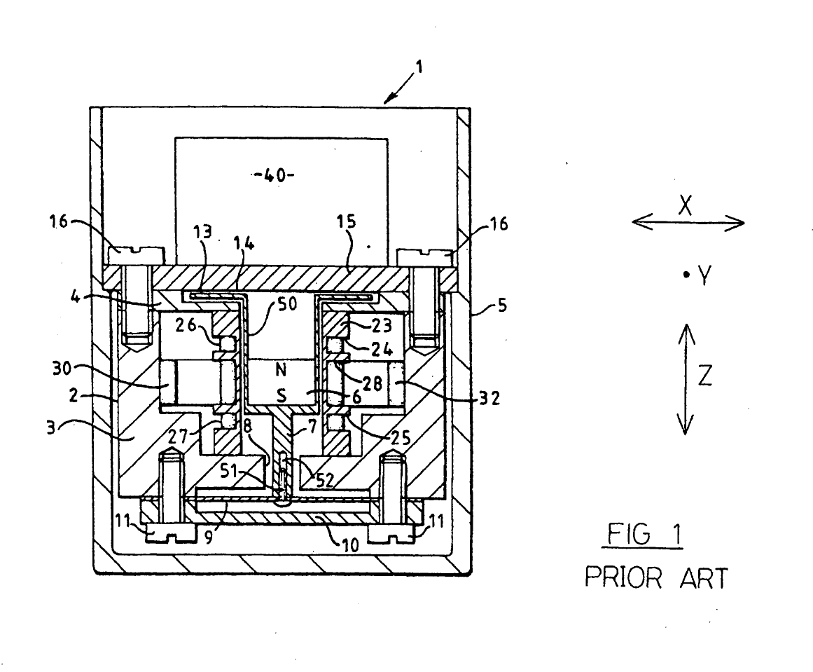

FIG. 1 of GB 2 213 272 is reproduced herein (also as FIG. 1) for ease of reference. The magnet 6 and carrier 50 are constrained at one end by flexure 9. Forces acting upon the magnet, either as a result of accelerations or magnetic fields, are balanced by a radial force in the flexure and an opposing force from electrical currents flowing through the force coils 30,32 (in the X direction) and corresponding force coils for the Y direction which are not seen in FIG. 1 (but which are numbered 29 and 31 in GB 2 213 272). Thus, there is a magnetic sensitivity on the X axis from a radial magnetic field in the X direction and a magnetic sensitivity on the Y axis from a radial magnetic field in the Y direction. The Z axis is not sensitive to a magnetic field in the Z direction because such a field generates no force (torque) upon the magnet 6.

In order to seek to eliminate the effect of a magnetic field, GB 2 213 272 discloses magnetic shielding 5 which reduces magnetic fields acting in the X and Y directions to near zero.

However, magnetic shielding such as that disclosed has a first disadvantage in requiring great concentricity and mechanical stability of the shield 5 in order to minimise magnetically induced radial forces. The magnetic shielding also has a second disadvantage in increasing the overall size of the tri-axial accelerometer; removing the magnetic shielding allows a reduction in the overall size of the accelerometer without changing any of the other components, and allows its use in applications where an accelerometer such as that of GB 2 213 272 would not be possible.

### SUMMARY OF THE INVENTION

The present invention seeks to provide a tri-axial accelerometer similar to that of GB 2 213 272, but without magnetic shielding. Alternatively stated, magnetic fields acting upon the accelerometer are catered for in a different way than the magnetic shielding of GB 2 213 272. Preferred embodiments of the present invention have no magnetic shielding at all, but in other embodiments it is possible that some of the componentry surrounding the magnet provides some magnetic shielding, albeit not intentionally.

According to the present invention, there is provided a tri-axial accelerometer comprising a housing, a permanent magnet disposed within said housing, a flexural mounting element attached to said housing and mounting said magnet so that said magnet is displaceable with respect to three mutually perpendicular measurement axes in response to an applied force, and sensing means for sensing displacement of said magnet and for providing a respective output signal proportional to the component of the applied force along each of the three measurement axes, characterised in that means are provided to measure the magnetic field along two of the three mutually perpendicular axes, the measurement of the magnetic field being incorporated into the output signal.

The invention therefore uses separate means to measure the magnetic field (acting in the X and Y directions), and subtracts or removes the effect of that field from the output of the accelerometer.

Desirably, the means to measure the magnetic field in each of the two axes is a respective fluxgate. In this respect, it is known that in many applications of an accelerometer, a fluxgate will already be present to measure a component of the Earth's magnetic field, and the present invention can take advantage of the presence of such an instrument. In particular, a widespread application of a tri-axial accelerometer is in the control of a steerable drill bit used to drill for oil and gas, and the steering component would typically not only carry an accelerometer to determine the local direction of the Earth's gravitational field, but would also incorporate fluxgates to determine the local direction of the Earth's magnetic field.

The measurement of the magnetic field can be removed from the output signal of the accelerometer either by summing a suitably calibrated and scaled correction factor into the accelerometer output, or by removing the magnetic field measurement during calculation of the acceleration.

### BRIEF DESCRIPTION OF THE PREFERRED EMBODIMENTS

The invention will now be described in more detail, by way of example, with reference to the accompanying drawings, in which:

FIG. 1 reproduces FIG. 1 of GB 2 213 272 for ease of reference;

FIG. 2 shows an electrical circuit representative of a fluxgate for measuring a magnetic field; and

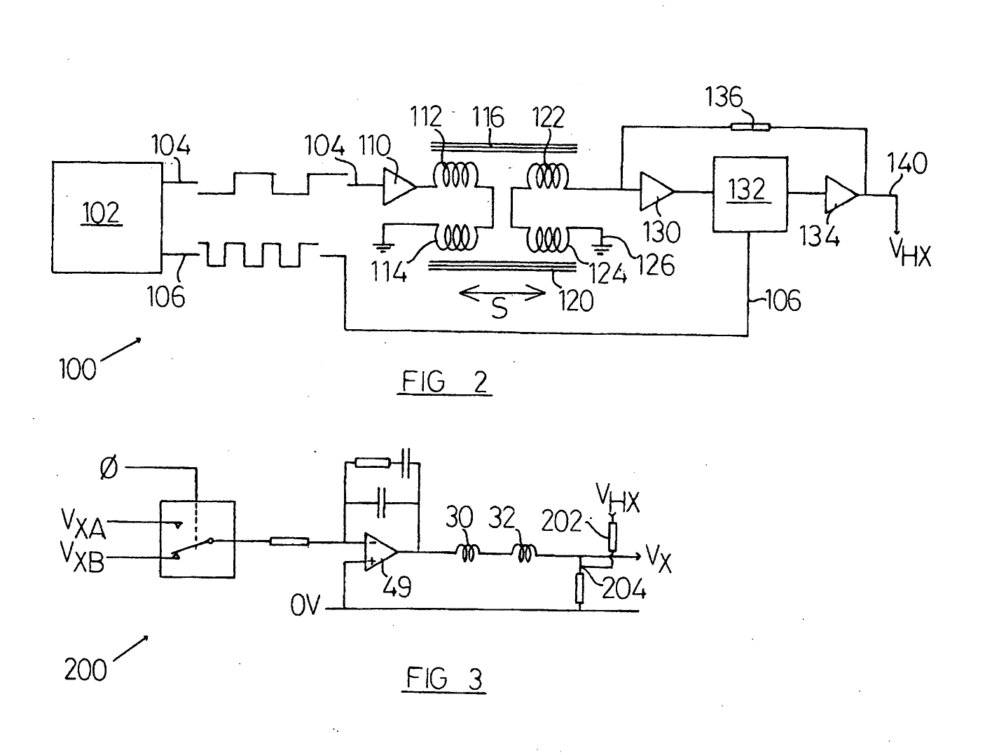

FIG. 3 shows an electrical circuit similar to that of FIG. 5 of GB 2 213 272 for measuring acceleration in a chosen direction, into which the output of the fluxgate is incorporated.

### DETAILED DESCRIPTION

FIG. 1 reproduces a prior art arrangement, specifically FIG. 1 of granted GB patent 2 213 272. A full description of that document is not necessary in this application, and reference is made to the original document for a full description.

An element of FIG. 1 which is particularly relevant to the present invention is the magnetic shielding provided by casing 5, which casing is electrically insulated from the housing 2, and is made from a magnetic alloy such as radiometal.

In the present invention on the other hand, the casing 5 is omitted, and in preferred embodiments the remaining components of FIG. 1 are utilised without modification. Accordingly, in embodiments of the present invention, the magnet 6 experiences not only forces induced by acceleration (which it is desired to measure), but also torque induced by magnetic field in the X and Y directions (which it is desired to eliminate or ignore).

Specifically, a magnetic field in the X direction, i.e. left/right in the plane of the paper as viewed in FIG. 1, will induce a rotational torque upon the magnet in the plane of the paper (i.e. the X-Z plane), in either the clockwise or counter-clockwise direction depending upon the field direction. Similarly, a magnetic field in the Y direction, i.e. into/out of the plane of the paper as viewed in FIG. 1, will induce a rotational torque upon the magnet in the plane perpendicular to the paper and from top to bottom of the paper (i.e. the Y-Z plane). On the other hand, a magnetic field in the Z direction, i.e. top/bottom of the paper as viewed will induce no torque upon the magnet 6 as the magnet 6 is arranged with its poles aligned with the Z direction.

A magnetic field in the X or Y directions will not induce movement of the magnet 6, but will induce torque, and because the magnet is held at one of its ends by the plate 9, that torque will result in movement of the support member 7, and in particular movement of the annular plate 13 relative to the circuit board 15. As is stated in GB 2 231 272, and in particular with reference to FIG. 3 of that document, the circuit board 15 carries another plate which is separated into four quadrants or plate portions. Two of the plate portions are aligned with the X-axis and two are aligned with the Y-axis, (the plate portions are numbered 18-21 in FIG. 3 of GB 2 213 272).

Accordingly, movement of the plate 13 in the X and Y directions relative to the plate portions carried by the circuit board 15 results in a change of the capacitance between the plate 13 and the respective plate portions which will be measurable.

The object of the present invention is to permit the movement of the plate 13 which is induced by a magnetic field to be distinguished from the movement of the plate 13 induced by accelerations, so that the output signal which is indicative of the acceleration is not distorted or corrupted by a magnetic field.

In order to eliminate the magnetic field from the output signal it is first necessary to measure the magnetic field, and in this embodiment this is achieved by a pair of fluxgates 100, one aligned with the X axis of the accelerometer 1, the other aligned with the Y axis of the accelerometer 1.

A suitable electrical circuit for a fluxgate 100 is shown in FIG. 2. This comprises a waveform generator 102 which produces two square wave outputs, a first drive signal along line 104 and a second demodulating signal along line 106. The frequency of the demodulating output is twice that of the drive output, and these outputs are out of phase as shown in FIG. 2.

The line 104 is connected to the input of an amplifier 110, the output of which is connected in series to a first input coil 112 and a second input coil 114. The input coils 112 and 114 lie adjacent to respective ferromagnets 116, 120. The ferromagnets 116, 120 extend beyond the input coils 112, 114 and also lie adjacent respective output coils 122,124.

The output coils 122, 124 are arranged in series between an earth point 126 and the input of a pre-amplifier 130.

The output of the pre-amplifier is connected to a phase sensitive demodulator 132 which is also connected to line 106 so that the phase sensitive demodulator receives the demodulating waveform signal. The output of the phase sensitive demodulator 132 is connected to an output amplifier 134, and a feedback resistor 136 is connected between the output of the output amplifier 134 and the input of the pre-amplifier 130.

The ferromagnets 116, 120 are arranged to be parallel with each other, and also parallel to the axis of each of the respective coils 112, 114, 122, 124, that axis defining the sensing axis S of the fluxgate 100.

The coil 112 is designed to match the coil 114, the coil 122 is designed to match the coil 124, and similarly the ferromagnet 116 matches the ferromagnet 120. Accordingly, in the absence of an external magnetic field, the magnetic field induced into the ferromagnet 116 by the coil 112 exactly matches the opposing magnetic field induced into the ferromagnet 120 by the coil 114, and the current induced in the coil 122 by the ferromagnet 116 exactly matches the opposing current induced in the coil 124 by the ferromagnet 120, during each cycle of the drive signal.

It is arranged that the ferromagnets 116, 120 reach saturation during each cycle of the drive signal, and in the absence of a magnetic field the ferromagnets 116, 120 will reach saturation at the same time in each cycle.

In these circumstances, the current induced in the coil 122 directly opposes the current induced in coil 124 and no current flows to the preamplifier 130, so that the output of the output amplifier 134 is also zero.

In the presence of a magnetic field acting in the direction of the sensing axis S, however, the magnetic field will reinforce the magnetic field induced in one of the ferromagnets 116, 120, and oppose the magnetic field induced in the other of the ferromagnets (depending upon the direction of magnetisation of the ferromagnets during that part of the cycle of the drive signal). This causes the system to become unbalanced with one of the ferromagnets 116, 120 reaching saturation before the other, and consequently the current induced into the coils 122, 124 no longer balances for all of each half-cycle of the drive signal. A resultant current therefore flows into the pre-amplifier during a part of each half-cycle of the drive signal.

The resultant current is demodulated by the phase sensitive demodulator 132 and amplified by the output amplifier 134, so that a signal V_{HX} is outputted along the line 140, which signal V_{HX} is proportional to the magnetic field H_{X} parallel to the sensing axis S of the fluxgate 100 (the fluxgate 100 of FIG. 2 having its sensing axis S aligned with the X axis of the accelerometer).

FIG. 3 shows a force balance circuit substantially identical to that shown in FIG. 5 of GB 2 213 272. A complete explanation of the circuit is provided in that earlier document and will not be repeated in its entirety here. However, in general terms the circuit 200 acts to provide current through force balance resistors 30, 32 (see FIG. 1) so as to oppose movements of the magnet 6 and keep the magnet 6 in its null or zero position.

The force balance circuit 200 of FIG. 3 is for the X direction, and it will be understood that an identical circuit is provided for the Y direction. The inputs to the force balance circuit V_{XA} and V_{XB} comprise voltage signals indicative of a change in capacitance between the plate 13 and the respective plate portions of the circuit board 15 which are aligned with the X direction, and so are dependent upon movements of the plate 13 in the X direction (i.e. the plate portions numbered 19 and 21 in GB 2 213 272). The circuit 200 can provide a current through the force balance resistors 30 and 32 proportional to the movement of the plate 13 and so as to oppose the movement of the plate 13, as described in GB 2 213 272.

In embodiments of the present invention there is no magnetic shielding, so that the signals V_{XA} and V_{XB} are dependent not only upon movements induced in the plate 13 by acceleration, but also movement induced in the plate 13 by torque resulting from a magnetic field in the X direction. The circuit of FIG. 3 upstream of the force balance resistors 30, 32 cannot distinguish between those movements, and will oppose both types of movement equally, resulting in the magnet 6 being moved to a null or zero position in which the plate 13 is centrally located with respect to the plate portions upon the circuit board 15.

In this regard, it will be noted that the null or zero position of the magnet 6 in the presence of a magnetic field may not be the same as the null or zero position absent a magnetic field, because of deviations in the support 7 caused by the torque upon the magnet 6. The very high amplifications used, however, mean that actual movement of the magnet 6 is very small indeed, for example of the order of microns.

In addition, actual movement of the magnet 6 in the presence of a magnetic field is of no consequence to operation of the device, since the plate 13 will still be centrally located with respect to the plate portions and movement induced by acceleration will still be responded to and opposed.

What is important, however, is that the measured magnetic field be compensated for in the output signal V_{X} of the circuit 200, or otherwise be removed from the measured acceleration. In the present embodiment, the magnetic field is removed electrically, i.e. the output signal V_{HX} from the fluxgate 100 is added to the voltage output of the circuit 200 (it can readily be arranged that the output signal V_{HX} is made negative if the output from the amplifier 49 is positive, and vice versa.

In order to determine the correct scale factor for the signal V_{HX}, a resistor 202 is used between the output from the output amplifier 134 of the circuit 100 and the connection 204 where the signal V_{HX} is communicated to the circuit 200.

The size of the resistor 202 is determined by calibration. For example, the accelerometer is oriented with its Z axis vertical. A known magnetic field is then applied horizontally and the accelerometer rotated. In such circumstances there are no accelerations in the X and Y directions, so that the outputs V_{X} and V_{Y} should both be zero. The output from the amplifier 49, and the output V_{HX} from the circuit 100 (and similarly the output V_{HY}) will not be zero, however, because of the applied magnetic field, and the values of these outputs will change cyclically with rotation of the accelerometer. With a particular value for the resistor 202, however, for each of the circuits 200 (i.e. for the X and Y directions respectively) the signals will cancel out so that the output signal V_{X}, and similarly the output signal V_{Y}, remain zero as the accelerometer is rotated.

Alternatively, the measured magnetic field can be removed during the calculation of the acceleration. Thus, it will be understood that the output signal V_{X} is not a measure of the acceleration but is proportional to the acceleration. Suitable calibration and calculation is required to determine the actual acceleration for the measured output signal V_{X}. When the accelerometer is subsequently in use, the signal V_{HX}, which it itself suitably calibrated, can be incorporated into the calculation to remove the effect of the magnetic field from the calculated acceleration (and similarly for the output in the Y direction).

It will be understood that a fluxgate is not required for the Z axis since the accelerometer is not sensitive to magnetic fields in that direction, i.e. the Z axis is aligned with the axis joining the poles of the magnet and so no torque is generated by a magnetic field in that direction. The accelerometer can, however, measure accelerations in the Z direction as is described in GB 2,213,272.

1. A tri-axial accelerometer comprising a housing, a permanent magnet disposed within said housing, a flexural mounting element attached to said housing and mounting said magnet so that said magnet is displaceable with respect to three mutually perpendicular measurement axes in response to an applied force, and sensing elements for sensing displacement of said magnet and for providing a respective output signal proportional to the component of the applied force along each of the three measurement axes, wherein a magnetic field detector is provided to measure the magnetic field along two of the three mutually perpendicular measurement axes, the measurement of the magnetic field being incorporated into the output signal.

2. A tri-axial accelerometer according to claim 1, wherein the magnetic field detector is a pair of fluxgates.

3. A tri-axial accelerometer according to claim 2, wherein the sensing axis of each fluxgate is aligned with one of the respective mutually perpendicular measurement axes.

4. A tri-axial accelerometer according to claim 3, wherein the sensing elements comprise a first capacitor plate fixed to the housing and a second capacitor plate fixed to the magnet, said first capacitor plate comprising separate plate portions, whereby movements of the magnet along one measurement axis cause changes in capacitance between respective first capacitor plate portions and the second capacitor plate, the accelerometer having an electrical circuit for generating the output signal for the one measurement axis, the electrical circuit having an output and being responsive to said changes in capacitance, the electrical circuit having at least one electrical coil through which an electric current can be passed to impart a return force upon the magnet, the fluxgate having its sensing axis aligned with said one measurement axis, the fluxgate having an output line, said output line being connected to the electrical circuit between said at least one electrical coil and the output of the electrical circuit.

5. A tri-axial accelerometer according to claim 4, wherein a resistor is located in the output line of the fluxgate.

6. A tri-axial accelerometer according to claim 5, wherein the value of the resistance of the resistor is determined by a calibration procedure.

7. A tri-axial accelerometer according to claim 1 with substantially no magnetic shielding for the permanent magnet.

8. A tri-axial accelerometer according to claim 1, wherein the axis joining the poles of the magnet is aligned with one of the three mutually perpendicular measurement axes, and wherein the magnetic field detector is provided to measure the magnetic field along the other two of the three mutually perpendicular measurement axes.

9. A system comprising a steerable drill bit and a tri-axial accelerometer for determining the local direction of the Earth's gravitational field, the accelerometer comprising a housing, a permanent magnet disposed within said housing, a flexural mounting element attached to said housing and mounting said magnet so that said magnet is displaceable with respect to three mutually perpendicular measurement axes in response to the gravitational field, and sensing elements for sensing displacement of said magnet and for providing a respective output signal proportional to the component of the gravitational field along each of the three measurement axes, wherein at least two perpendicularly aligned fluxgates are provided to determine the local direction of the Earth's magnetic field, the measurements of the magnetic field being incorporated into the output signal.

10. A method of calculating acceleration with a tri-axial accelerometer, the tri-axial accelerometer comprising a housing, a permanent magnet disposed within said housing, a flexural mounting element attached to said housing and mounting said magnet so that said magnet is displaceable with respect to three mutually perpendicular measurement axes in response to an applied force, and sensing elements for sensing displacement of said magnet and for providing a respective output signal proportional to the component of the applied force along each of the three measurement axes, wherein a magnetic field detector is provided to measure the magnetic field along two of the three mutually perpendicular measurement axes, the method comprising the step of incorporating the measurement of the magnetic field into the output signal.

11. The method according to claim 10 comprising the additional step of calibrating the output of the magnetic field detector with the output signal.

12. The method according to claim 10 comprising the step of removing the magnetic field measurement during calculation of the acceleration.
